(19) United States
(12) Patent Application Publication
(10) Pub. No.: US 2007/0119763 A1
(43) Pub. Date: May 31, 2007

(54) Floating sequencing batch reactor and method for wastewater treatment

(76) Inventor: Thomas H. Probst, Waukesha, WI (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/482,541

(22) Filed: Jul. 7, 2006

Related U.S. Application Data
(60) Provisional application No. 60/697,346, filed on Jul. 7, 2005.

(51) Int. Cl. B01D 15/00

(52) U.S. Cl. 210/198.1

(57) ABSTRACT

A floating sequencing batch reactor system and method of wastewater treatment in which a floating solids/liquid separation operation is included within the wastewater treatment cycle as an alternative and/or addition to a conventional gravity settling operation.

This application claims the benefit of U.S. Provisional Patent Application No. 60/697,346, filed on Jul. 7, 2005.

### BACKGROUND OF THE INVENTION

### FIELD OF THE INVENTION

The present invention relates generally to the field of treatment of wastewater, and more particularly to an improved system and method for treating wastewater containing contaminants, which system and method offer a broad array of advantages over conventional sequencing batch reactors and/or activated sludge wastewater treatment systems, including lower operating costs, smaller size, higher rates of operation, high oxygen transfer efficiency, and a decreased level of excess sludge production.

With an increased awareness of problems with water quality, particularly those caused by the discharge of wastewater from industrial sources, has come a demand for improved equipment and methods to treat wastewater prior to discharging it into a sewer, to surface water, reuse for irrigation, recycling or other “grey water” applications, or to other destination for effluent discharge. While such treatment systems and methods are generally not required to produce potable water, they are increasingly required by law to enhance the quality of wastewater prior to discharging it as effluent. For industrial waste, this treatment process must typically remove certain types of pollutants such as organic contaminants, nitrogen and phosphorus, metals, and suspended solids.

The first wastewater treatment systems were of simple design, with a single container or tank being used for both treatment of the wastewater and the removal of solids from the wastewater, typically by allowing them to settle out. These early wastewater treatment systems were not aerated, and typically generated foul odors as a byproduct of the process utilized by these systems. Over time, these early wastewater treatment systems evolved into systems which use a popular type of wastewater treatment process referred to as the activated sludge wastewater treatment method.

The conventional, continuous flow activated sludge wastewater treatment systems and methods utilize an aeration tank/biological reactor followed by a solids/liquid separator and/or a secondary clarifier to remove separated solids from the liquid, which is discharged by the system. Most conventional activated sludge wastewater treatment systems also include equalization tanks/equalization capacity for storage of wastewater and/or treated effluent during surges or less-than-capacity demands.

As its name suggests, the contents of the aeration tank are aerated and mixed to facilitate an aerobic reaction (a reaction taking place in the presence of oxygen) which is facilitated by the presence of activated sludge. This activated sludge, which is an accumulation of microorganism-rich residue (“sludge”) contained in the solids which are separated from the liquid in the solids/liquid separator, is seeded into the incoming wastewater in the aeration tank. In conventional activated sludge wastewater treatment systems, the concentration of activated sludge solids is typically 2,000 to 5,000 milligrams per liter in the aeration tank.

The aerobic reaction which takes place in the aeration tank includes three types of phenomena—absorption, adsorption, and biological digestion. Absorption takes place when a contaminant is absorbed into the cell wall of the bacteria contained in the activated sludge. Adsorption, on the other hand, is a surface phenomenon which takes place when there is an interaction between a contaminant and the surface of the activated sludge whereby the contaminant adheres to the surface of molecules of the bacteria. Any one of these three phenomena will result in contaminants reacting with the bacteria contained in the activated sludge. Biological digestion takes place when the bacteria contained in the activated sludge consume waste constituents contained in the wastewater. Biological digestion can occur after the material has been absorbed or adsorbed. Other mechanisms of treatment that may be involved include, but are not limited to, flocculation/coagulation, sedimentation, or enmeshment reactions that are induced by the activated solids or produced by the change of wastewater chemistry induced by the bacterial solids.

As mentioned above, the reaction is an aerobic reaction occurring in the presence of oxygen, which decreases both the amount of time required for the reaction to occur and the level of foul odors produced by the reaction. Typically, the aeration and mixing may be produced by injecting compressed air or oxygen into the mixture, typically through diffuser devices located near the bottom of the aerator tank. As the air bubbles to the surface of the mixture, the diffused air provides both oxygen to the mixture and a vigorous mixing action. The amount of material contained in the wastewater may be characterized by the “chemical oxygen demand” or COD of the material. A chemical oxygen demand of one pound indicates that the material contained in the wastewater requires one pound of oxygen to degrade.

Air may also be added by the churning action of mechanical mixers located near the surface of the mixture contained in the aeration tank. In still another variation, mixing of the contents of the aeration tank may be caused by hydraulic pumping in which liquid is pumped out of the tank and back in through nozzles causing highly efficient mixing of the contents of the aeration tank. In a still further variation, air nozzles may be arranged around the liquid nozzles to further stimulate the mixing and simultaneously provide oxygen to the mixture. Still further variations include processes known as extended aeration and contact stabilization, both of which omit the primary settling step, and high-purity oxygen aeration, which can substantially reduce both the aeration time and the size of the aeration tank.

The conditions which are thus provided in the aeration tank promote the growth of the microorganisms introduced in the activated sludge with the resultant reaction removing contaminants from the wastewater. In conventional activated sludge technology, a predetermined period of time related to the strength of the wastewater, kinetics, environmental conditions and treatment objectives is required for the mixture to react in the aeration tank in the process. This time is required to allow the bacteria in the aeration tank to react with the contaminants contained in the wastewater, with much of the material being oxidized by the microorganisms. Generally, in conventional activated sludge processes, the contaminants are completely digested in the aeration tank.

In some wastewater treatment systems, the mixture is then allowed to flow from the aeration tank into a solids/liquid separator. For example, the solids/liquid separator may be as simple as a secondary clarifier, which allows activated sludge to settle out by gravity. The clean liquid overflows from the separator and it is discharged as secondary effluent, while the activated sludge may be separated out in a settling tank. The bacteria tends to clump together and settle to the bottom of the settling tank, from which the activated sludge may be pumped out.

Some of the activated sludge will be recirculated back into the aeration tank, with this sludge being referred to as “return activated sludge” or RAS. The microorganisms contained in the return activated sludge are thus well acclimated to the environment in the aeration tank. The remaining activated sludge is treated and disposed of in a conventional solids processing technique which is well known to those skilled in the art. This sludge is referred to as “waste activated sludge” or WAS. In conventional activated sludge technology, the waste activated sludge may amount to as much as seventy percent of the sludge recovered in the solids/liquid separator.

The amount of excess activated sludge which is generated by an activated sludge waste treatment system may be controlled by a term referred to as “solid retention time” or SRT, which is the amount of time an average particle of solid material remains in the waste processing system. The solid retention time is inversely proportional to the relative volume of excess activated sludge which must be disposed of. Conventional extended activated sludge waste processing systems (designed for surface water discharge of effluent) have a solid retention time of approximately twenty days.

The excess solids produced may be determined by the yield of the activated sludge process multiplied by the mass of the contaminants removed. The effective yield may be measured in units of pounds of Total Suspended Solids (TSS) produced in the treatment of a pound of “chemical oxygen demand” or COD, which is a term commonly used to measure the amount of contaminants which are removed. The effective yield is an inverse function of the solids retention time. Conventional extended activated sludge waste treatment systems produce a yield of approximately 0.25 pounds of “total suspended solids” or TSS of excess activated sludge per pound of chemical oxygen demand of yield. Less conservatively operated systems can produce yields of 0.7 pounds of total suspended solids per pound of chemical oxygen demand removed.

The waste activated sludge is typically accumulated, and may be further biologically processed and/or dewatered prior to its ultimate disposal.

Conventional, continuous flow wastewater treatment systems, however, have several drawbacks. In particular, they require a significant amount of space and are, therefore, costly to purchase, install and maintain. Such systems are not appropriate for smaller residential, community and/or commercial applications.

The sequencing batch reactor (SBR) is an alternative activated sludge process for treating wastewater under batch and/or non-steady state conditions with equalization, aeration and clarification occurring in the same tank. Accordingly, the unit processes of the SBR and conventional activated sludge treatment systems are substantially the same except the SBR performs such operations in a single tank under a timed control sequence. Indeed, an SBR process is capable of achieving biological phosphorous removal, nitrification, denitrification and BOD removal in one reactor. A typical SBR process usually includes multiple SBRs in parallel; however, smaller businesses and entities may require one SBR within their wastewater treatment systems.

A typical SBR process has five basic operating steps/operations including, but not limited to, fill, react, settle, draw and idle—which together encompass one complete SBR cycle. During the fill mode, a “batch” of wastewater flows into the SBR tank and mixes with the activated sludge/mixed liquor settled in the tank from the previous cycle. The time allocated to the fill mode is variable and depends on factors including the influent flow rate and the degree and types of treatment desired. Typically, SBRs are designed to have a minimum fill time that corresponds to the peak hour flow (“PHF”) rate of the facility.

Fill modes/operations typically include one or more of the following variations in operation—static fill, mixed fill and aerated fill. During static fill, influent wastewater is added to the SBR without mixing or aeration, meaning there will be a high substrate (food) concentration when mixing of the tank begins. A high food to microorganism (F:M) ratio encourages the maximum biosorption of food and nutrients by the microorganisms.

Mixed fill is characterized by hydraulically mixing the influent wastewater with the activated sludge/biomass in the SBR to provide maximum contact between the microorganisms and the waste products to initiate biological reactions. Aerated fill is characterized by aerating the contents of the reactor to begin aerobic reactions in the SBR. In addition, an SBR may have more than one fill mode or a staged fill mode. For example, during a typical fill mode, aeration and mixing are typically cycled on and off to provide a substantial amount of substrate reduction, biological phosphorous removal, nitrification and denitrification.

During the react mode, aeration continues until complete organic and nitrogenous oxidation of the waste products occurs. However, the length and type of react mode determines the degree of treatment and can be tailored to achieve a desired contaminant level within the SBR. In addition, the SBR react mode can include periods of anoxic conditions to facilitate nitrogen removal and/or include anaerobic conditions for phosphorous removal.

The settle mode is typically provided under quiescent conditions in the SBR (i.e. mixing and aeration are terminated and the reactor tank is allowed to dissipate all hydraulic energy developed due to the mixing operations). The purpose of the settle mode is to allow solids separation to occur, leaving a concentrated sludge blanket accumulated at the bottom of the SBR tank with clarified effluent disposed above the sludge blanket. Unlike conventional activated sludge systems, in an SBR, there are no influent or effluent currents to interfere with the settling process. In certain other SBR systems, there can be some influent feed and/or agitation during the settle mode. However, regardless of the method used, the typical settling process can be lengthy and inconsistent, requiring up to about five hours for adequate settling to occur.

During the draw mode, treated effluent is removed from the tank. Removal is typically achieved using a floating or a fixed decanter. Floating decanters float on the surface of the water in the tank and are configured such that the inlet orifice is maintained just below the water surface to minimize the removal of solids. Fixed decanters are built into the side of the tank and are positioned at a location above the concentrated sludge blanket to minimize the removal of solids along with the treated effluent. However, regardless of the type of decanter, removal of the treated effluent from the SBR tank must be done carefully so as to not disturb the settled sludge layer—which, in turn, can deteriorate effluent quality.

The idle mode provides stand-by time while pretreatment of the wastewater in the next batch occurs, while a subsequent SBR operation is completed and/or while equalization occurs. Idle mode also provides down-time in which waste activated sludge is removed from the SBR, conditioning of the biomass occurs and/or backwashing of the aerator is performed.

SBR technology has several disadvantages. For example, bulking of sludge, organic and inorganic fine particulate solids, gassing within the reactor (from denitrification under aerobic conditions and/or methane and carbon dioxide generation under anaerobic conditions) and/or the presence of filamentous organisms in the SBR interferes with settling within the conventional SBR system. As a result, the conventional SBR settling and draw modes/operations can take extended periods of time (up to or more than about 5 hours) to achieve a desired given separation in a conventional SBR system. As such, chemical treatments and/or coagulants are sometimes added to assist in solids/liquid separation during the settling process.

Further, due to the settlement characteristics of sludge flocs the concentration of mixed liquor suspended solids (MLSS) is limited in conventional SBR.

In addition, the interface between the separated solids layer and the treated effluent is easily disturbed in a conventional SBR process. Accordingly, the treated effluent is decanted at slow flow rates, rendering the treated effluent difficult and time consuming to remove. In order to further ensure solids are not removed with the treated effluent, the draw mode is typically stopped well before the solids/liquid interface is disturbed leaving a large volume of treated wastewater inside the tank after every batch—rendering such system inefficient to operate. Nonetheless, even where such precautions are taken, use of a conventional SBR can require a secondary clarifier after biological processing in the SBR—requiring additional space and purchase of expensive capital equipment.

Also, the traditional SBR configuration includes use of a decanter system and/or the use of internal baffles/fins inside the tank—requiring additional components and control mechanisms, making the SBR system more expensive and complex to operate and maintain.

It is accordingly the primary objective of the present invention to provide an improved sequencing batch reactor and process for wastewater treatment which includes a floating solids/liquid separation mode as an alternative to or in addition to the settle mode of the traditional sequencing batch reactor. It is a related object of the present invention to provide a wastewater treatment process including a solids/liquid separation mode that achieves a higher quality effluent at reduced time durations over conventional SBR systems. It can be a related object of the present invention to provide a batch reactor system and process which essentially eliminates the need for secondary clarification and/or solids/liquid separation.

It is a further objective of the present invention to provide a sequencing batch reactor and process in which the activated sludge/biomass within the system is floated to the surface of the wastewater—yielding a more stable and concentrated solids layer than achievable in conventional SBR systems. Accordingly, due to the increased stability of the interface, it is a related object of the present invention to maximize the output of treated effluent from the sequencing batch process by permitting a larger volume of effluent to be decanted from the reactor at greater hydraulic rates over conventional SBR systems.

It can be an additional objective of the present invention to provide an improved flotation/floating sequencing batch and/or continuous system and method that can operate at increased MLSS concentrations over traditional SBR systems and which is therefore smaller and less expensive to initially purchase and install than a conventional SBR system. It can be a related object of the present invention to provide an improved SBR system which in turn provides an increased solids retention time, resulting in activated sludge that is acclimated to the influent waste stream—exhibiting more efficient biological treatment with less waste sludge production.

It is still another objective of the waste processing system of the present invention to improve solids/liquid separation by minimizing the effect of gassing and/or bulking of sludge by driving the solids to the reactor surface using dissolved air, oxygen or another flotation method. It is a still further objective of the waste processing system of the present invention that it present a simplified operating process which is easy to operate and which presents relatively few potential problems in its day-to-day operation.

The floating sequencing batch reactor system of the present invention must also be of construction which is both durable and long lasting, and it should also require little or no maintenance to be provided by the user throughout its operating lifetime. In order to enhance the market appeal of the FSBR system of the present invention, it should also be of inexpensive construction to thereby afford it the broadest possible market. Finally, it is also an objective that all of the aforesaid advantages and objectives be achieved without incurring any substantial relative disadvantage.

### SUMMARY OF THE INVENTION

The disadvantages and limitations of the background art discussed above are overcome by the present invention. With this invention, a floating sequencing batch reactor (FSBR) system and method of wastewater treatment is provided in which a floating solids/liquid separation operation is included within the wastewater treatment cycle as an alternative and/or addition to the conventional gravity settling operation in order to achieve all of the objectives mentioned above without incurring a single significant disadvantage. The present invention can be implemented in any wastewater treatment system and method requiring a solids/liquids separation system/operation., including any sequencing batch reactor (SBR) or hybrid-SBR system and/or any modified batch or continuous process known to those skilled in the art. As such the FSBR of the present invention can incorporate any required mechanical, chemical and/or biological processing steps and/or can be of virtually any design. Further, the flotation sequencing batch reactor and methods of the present invention can be implemented/retrofitted into any existing SBR system and process.

Accordingly, in part, the present invention includes floating sequencing batch reactor (FSBR) system including, in its simplest form, a reactor vessel, a wastewater inlet, a treated effluent outlet and/or decanting system, a gas/liquid distribution system and a control system. The reactor may be of any conventional type, size and shape and is designed based on the type of waste stream/contaminates to be removed, peak and average flow rates, timing requirements, upstream and downstream processing operations, location of the system, etc. as will be well known to those skilled in the art.

The gas/liquid distribution system performs several functions within the FSBR system and process of the present invention. First, the gas/liquid distribution system provides hydraulic mixing and/or aeration when mixing and/or aeration of the contents of the reactor are required by the particular operating stage of the FSBR process. In addition, the gas/liquid distribution system can also provide a solids flotation function wherein a liquid source (incoming wastewater, recirculated wastewater and/or treated effluent) is supersaturated with dissolved gas and released into the reactor.

The gas/liquid distribution system can include a saturation vessel which is supplied with gas or air from a compressed gas/air supply and a wastewater source drawn from one or more process streams, for example, from the incoming wastewater stream, from the reactor contents and/or from the treat effluent stream. The compressed gas/air supply preferably utilizes air; however, any type of gas may be used including, but not limited to, oxygen or ozone. The gas/liquid distribution system may also include a plurality of nozzles positioned within the tank at a location/position to maximize mixing and aeration of the reactor contents and to maximize flotation of the solids.

Accordingly, the gas/liquid distribution system of the FSBR system and method of the present invention preferably utilizes dissolved air flotation (DAF), induced air flotation, bubble air flotation, electrical gas flotation and/or fine bubble air flotation to induce flotation of the solids in the wastewater. However, any other mechanical, biological and/or chemical means known to those skilled in the art may be used to float the suspended solids to the top surface of the reactor contents It will be appreciated that the flotation function/operation of the gas/liquid distribution system may be achieved without the need for a saturation vessel and/or a compressed gas/air supply, as will be commonly understood by those skilled in the art.

The gas/liquid distribution system of the present invention (having integrated mixing, aeration and/or flotation functions) may be replaced by one or more systems for accomplishing the aeration, hydraulic mixing and/or flotation operations required for the FSBR process. In particular, each of the aeration, mixing and/or dissolved gas flotation functions may be optionally separately provided as part of the FSBR system of the present invention.

The FSBR control system can be any type of control system known to those skilled in the art, including, for example a programmable logical controller (PLC) controller, PC software, distributed control systems, etc. As such, the control system can be in communication with one or more devices for controlling or monitoring one or more process parameters/variables such as time, temperature, pressure, pH, oxygen demand (DO and/or BOD), TOC, conductivity, oxidation/reduction potential (ORP), solids concentrations, specific contaminant concentrations including the on-line analysis of the major nutrients (ammonia, nitrate, nitrite and phosphate), turbidity and/or flowrates—as required by the control scheme of the FSBR process and as will be well known to those skilled in the art. Where an integrated gas/liquid distribution system is provided, the control system is configured to permit mixing-only, aeration-only, mixing and aeration and flotation operations—where required by the FSBR process.

A preferred FSBR process typically includes, but is not limited to, five modes or stages of operation: Fill, React, Solids/Liquid Separation, Draw and Idle. In addition, the FSBR process can include the deletion and/or repetition of one or more of these stages, if required by a given end-use application. The FSBR method of the present invention can include any wastewater treatment system operation, process or method including those requiring aerobic or anaerobic conditions, chemical treatment, phosphorous removal, nitrification, denitrification, or any treatment process known to those skilled in the art.

The Fill and React stages of the FSBR process of the present invention can be practiced substantially similar to that of conventional SBR and/or hybrid SBR systems. As such, the Fill and React stages of the FSBR process can include periods of aeration, mixing or both—as required by the given waste treatment application.

During the Solids/Liquid Separation stage of the FSBR process of the present invention, the flotation operation of the gas/liquid distribution system is activated. Saturated wastewater is released into the reactor causing small/fine bubbles to form throughout the reactor. The bubbles attach to the solids dispersed in the wastewater, decreasing the specific gravity of the solid particles and causing the solids to float to the top of the reactor. The floated solids form a thickened solids layer above the clarified effluent. Heavier suspended solids such as sand or large particles, not capable of flotation within the FSBR, sink to the bottom of the reactor forming a heavy sediment layer.

Accordingly, the Solids/Liquid Separation stage effects solids/liquid separation by floating the suspended solids in the wastewater to the surface of the water. The difference in the specific gravity of the floated solids and that of the water is sufficient to render the solids/liquid interface relatively stable. The Solids/Liquid Separation stage may continue until a desired effluent quality is obtained and/or for a given period of time, depending on the required control scheme of the FSBR. The Solids/Liquid Separation stage may also include the addition of chemicals such as coagulants and/or flocculants, as required for the given waste stream and/or the final end-use application of the FSBR system.

At the start of the Draw stage, the floated solids are disposed above the treated/clarified effluent. Thus, the treated effluent can be removed from the reactor by simply opening the outlet and withdrawing the clarified effluent. The floated solids layer will drop to the bottom of the reactor as the clarified effluent is withdrawn. The Draw stage is complete when the level in the reactor reaches a certain position, the effluent quality reaches a certain value and/or an increase in solids is detected in the effluent stream. Rather than providing an outlet or opening in the side of the reactor for decanting off the clarified effluent, any type of decanter mechanism including a floating or a fixed decanting system can be used to draw off the treated effluent.

During the Idle stage, waste activated sludge, if any, is removed from the reactor using an optionally provided waste activated sludge removal system.

Thus, in part, the present invention also provides a method of wastewater treatment including contacting an incoming wastewater stream with activated sludge in a reactor vessel, providing gas-saturated liquid to the reactor for a sufficient time to cause the mixed liquor suspending solids to float to the surface of the reactor contents, and drawing off clarified effluent at a point within the reactor below the floating suspended solids. In particular, the method includes a solids/liquid separation mode in which the suspended biomass is driven to the surface of the reactor tank and a draw mode in which clarified effluent layer is withdrawn from the tank—in order to achieve a higher quality effluent and/or a larger batch volume of effluent over conventional systems.

The apparatus of the present invention is of a construction which is both durable and long lasting, and which will require little or no maintenance to be provided by the user throughout its operating lifetime. The apparatus of the present invention is also of inexpensive construction to enhance its market appeal and to thereby afford it the broadest possible market. Finally, all of the aforesaid advantages and objectives are achieved without incurring any substantial relative disadvantage.

### DESCRIPTION OF THE DRAWINGS

These and other advantages of the present invention are best understood with reference to the drawings, in which:

FIG. 1 is a somewhat schematic process flow diagram of a prior art SBR system used to remove contaminants from wastewater;

FIG. 2 is a process flow diagram of a prior art SBR process;

FIG. 3 is a somewhat schematic process flow diagram of an FSBR system of the present invention;

FIG. 4 is a process flow diagram of a FSBR process of the present invention;

FIG. 5 is a somewhat schematic process flow diagram of the FSBR system and process shown in FIGS. 3 and 4, illustrating the reactor during the Fill stage;

FIG. 6 is a somewhat schematic, simplified process flow diagram of the FSBR system and process shown in FIGS. 3 through 5, illustrating the reactor during the React stage;

FIG. 7 is a somewhat schematic, simplified process flow diagram of the FSBR system and process shown in FIGS. 3 through 6, illustrating the reactor during the Solids/Liquid separation stage;

FIG. 8a is a somewhat schematic, simplified process flow diagram of the FSBR system and process shown in FIGS. 3 through 7, illustrating the reactor at the beginning of the Draw stage;

FIG. 8b is a somewhat schematic, simplified process flow diagram of the FSBR system and process shown in FIGS. 3 through 7, illustrating the reactor at the completion of the Draw stage; and

FIG. 9 is a somewhat schematic, simplified process flow diagram of the FSBR system and process shown in FIGS. 3 through 8b, illustrating the reactor during the Idle stage.

### DETAILED DESCRIPTION OF THE PREFERRED EMBODIMENT

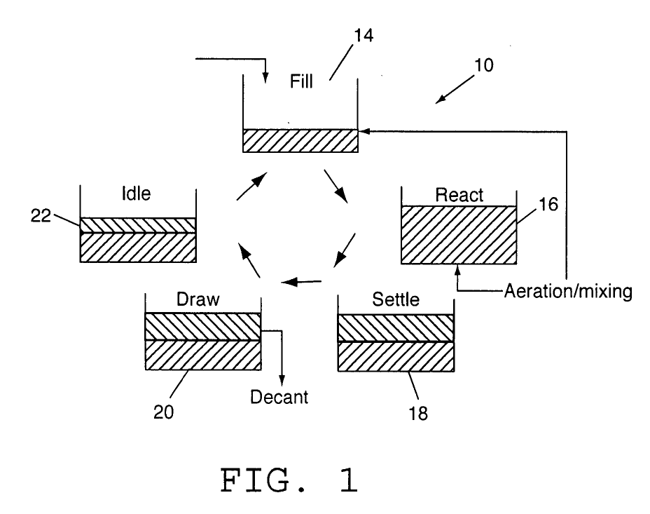

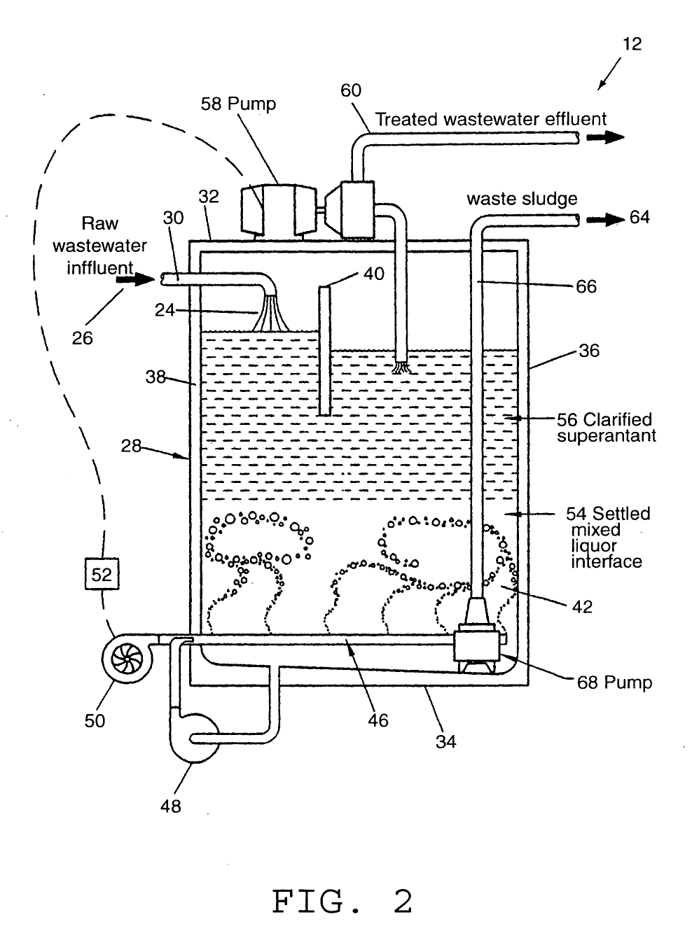

Prior to a discussion of the preferred embodiment of the present invention, it is useful to briefly discuss a conventional SBR system and process. In particular, FIG. 1 illustrates a flow diagram for a typical SBR process 10 and FIG. 2 illustrates a conventional configuration for an SBR system 12 of the prior art.

As first illustrated in FIG. 1, it can be seen that the typical SBR goes through a series of five steps or stages of operation during a treatment cycle including fill 14 , react 16, settle 18, draw 20 and idle 22. It will be appreciated that not every SBR will include each of the five common stages. In addition, it will be appreciated that some of the stages may be combined and/or repeated to achieve the required processing conditions for the biological digestion of the solids by the microorganisms.

Turning next to FIG. 2, in addition to FIG. 1, during the fill stage 14, influent wastewater 24 containing contaminants from a source of wastewater 26 enters a reactor tank 28 through a feed line 30. It will be appreciated that the influent wastewater 24 may be pretreated before entering the tank 28, for example, the influent wastewater may be chemically treated, thermally treated, screened, and/or undergone any required pretreatment operation as will be well known to those skilled in the art. Further, the wastewater 24 may enter the tank 28 from an equalization tank or other holding facility, as will also be well known to those skilled in the art. The fill stage 14 may be a static fill (no aeration or mixing), a mixed fill and/or an aerated fill, depending on desired operation of the SBR and/or the treatment requirements of the wastewater stream.

The tank 28 contains a top 32, a bottom 34, opposing side portions 36 and 38 and an optional baffle 40 for avoiding harsh currents within the tank 28 when required by the SBR process. The tank 28 includes settled activated sludge 42 at the bottom of the tank 28 from a previous SBR cycle. Typically, the concentration of activated sludge solids in conventional SBR (the total suspended solids, TSS) can range from about 4,000 to about 5,000 milligrams per liter.

After the tank 28 is filled, hydraulic mixing and aeration occurs using a jet aeration system, indicated generally at 46, during the react stage 16. The jet aeration system 36 includes a pump 38 for continually circulating/mixing the wastewater in the tank 18 and for ensuring sufficient oxygen transfer. The jet aeration system 36 also includes a source of oxygen or air from a blower 40, air compressor or other source, as will be well known to those skilled in the art, for providing the required oxygen and keeping the solids in suspension. Either oxygen in air, pure oxygen or enriched oxygen can be introduced into the bottom of the tank 18 using the jet aeration system 36.

It will be appreciated that aeration and mixing of the tank 28 can encompass two separate systems. This may be accomplished by providing air to a compressor pump, which provides the compressed air to the bottom of the tank 18 (such as coarse and/or fine bubble diffusers) and providing a separate mechanical mixer. Other ways of introducing oxygen to the tank 18 and/or mixing the contents of the tank 18 are well known in the art.

The tank 28 also includes a control system 52 for controlling/monitoring the mixing and aeration of the tank 28 during and each stage of the SBR process, and more particularly, during each phase of the react stage of the SBR process. For example, the SBR can be controlled to provide intermittent mixing and aeration of the tank 28 depending on the type of reaction conditions required by the particular phase of the react stage—such that aerobic, anoxic and/or anaerobic conditions can be obtained during the react stage.

FIG. 2 best illustrates the settle stage 18 of the conventional SBR system 12. The settle stage 18 is typically operated at quiescent conditions (i.e. unassisted gravity settling of the biomass) such that the activated sludge/biomass settles to the bottom 34 of the tank 28 leaving the clarified effluent 56 disposed thereabove. During this stage, typically there is no influent or effluent flow from the tank 28 in order to avoid turbulence that may disturb the solids layer and/or the solids/liquid interface 54 within the tank. If some flow is permitted, great care is taken to avoid unwanted mixing or currents within the clarified effluent 56.

The settle stage 18 can be lengthy in the conventional SBR process taking up to or more than about five hours to achieve the required effluent quality and/or solids accumulation at the bottom of the tank. As a result, due to time constraints of the batch process, the settle stage 18 is typically stopped well-before the completion of solids settling has occurred. Accordingly, the conventional SBR process may include addition of chemicals such as flocculants or coagulants to assist in the solids/liquid separation. In addition, because the solids accumulate on the bottom of the conventional SBR tank 18, as shown in FIG. 2, the aeration system 46 can become clogged—requiring frequent routine maintenance of the SBR tank 28.

During the draw stage 20, the clarified effluent 56 is decanted from the tank 28 using a pump 58 through the line 60. The treated effluent 56 may be pumped into an equalization tank, a filtration unit and/or any treatment process as required by the remaining constituents of the exiting effluent stream. As described elsewhere herein, other decanting methods, such as a floating decanter can alternatively be used to decant the treated effluent 56.

Importantly, in a conventional SBR, the draw stage must be carefully executed in order to ensure that the solids/liquid interface 54 is not disturbed by any currents within the tank 28 while the treated effluent 56 is being extracted. Indeed, because solids/liquid separation is accomplished using gravity—the interface between the activated sludge solids and the clarified effluent is relatively unstable. Thus, the treated effluent 56 must be withdrawn from the tank at slow hydraulic rates. Further, removal of the treated effluent 56 from the tank 28 is stopped before the current of the exiting water causes solids to be disturbed or withdrawn. As such, a significant amount of treated effluent is left in the tank 28 after each SBR cycle—rendering the conventional SBR process inefficient to operate.

During the idle stage 22, waste sludge 64 is removed through a line 66 by the pump 68 when required by the process. During the idle stage, conditioning of the biomass and/or backwashing of the aerator may also be performed.

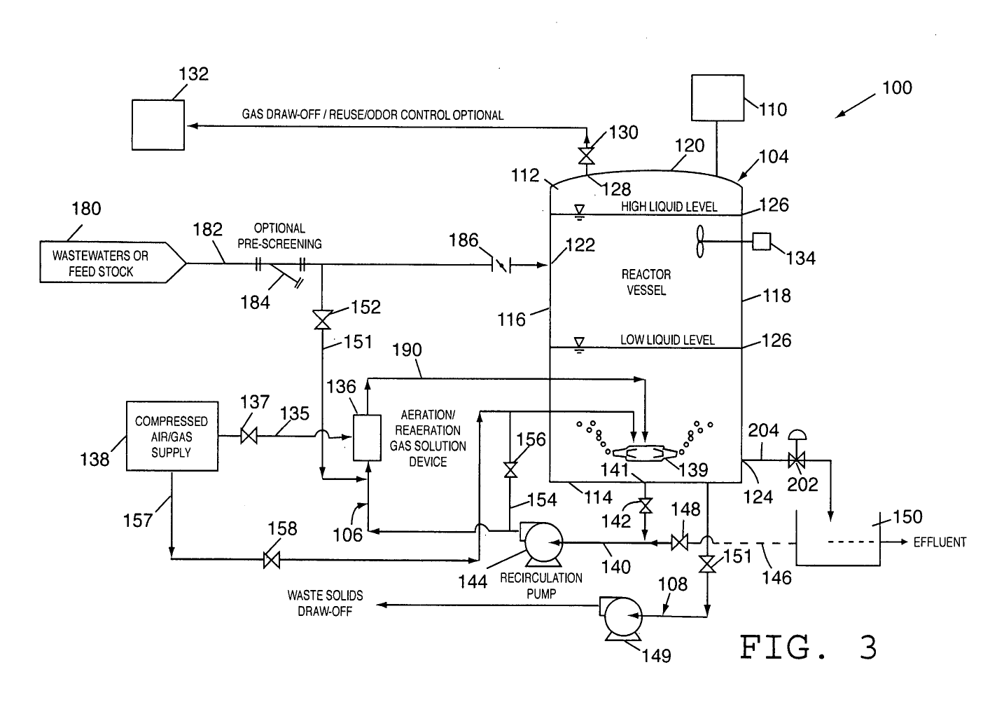

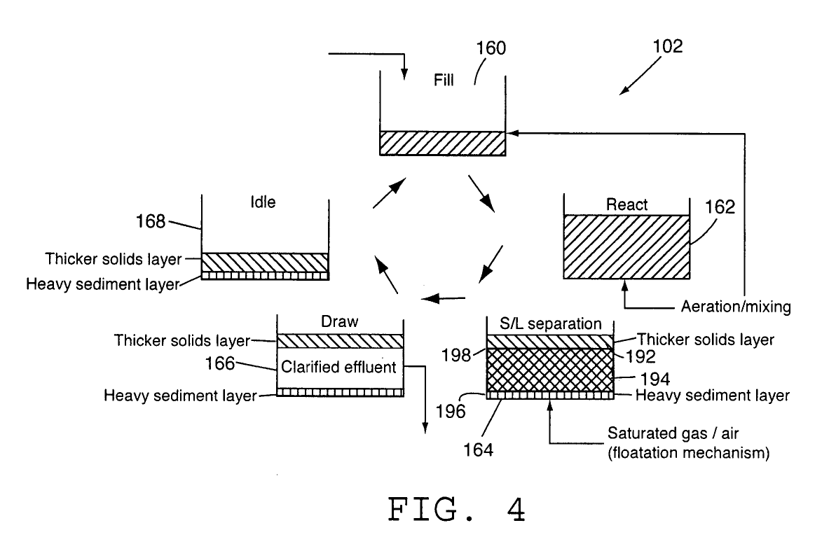

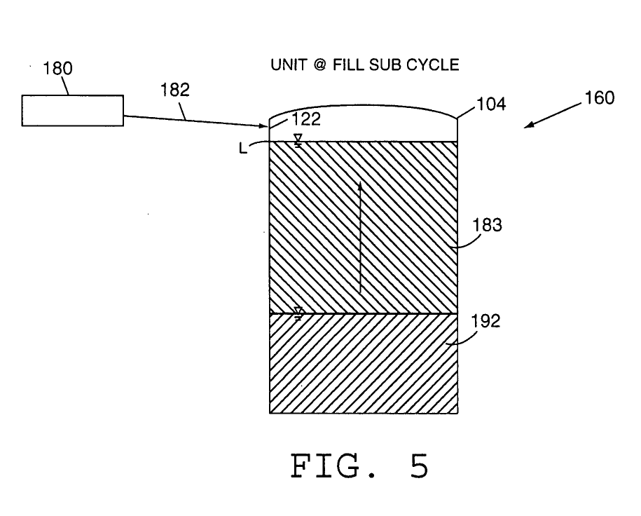

Turning next to FIGS. 3 through 8, a floating sequencing batch reactor (FSBR) system 100 and FSBR process 102 of the present invention is shown. In particular, FIG. 3 illustrates the preferred FSBR system 100 configuration and FIG. 4 illustrates the preferred FSBR process 102 flowchart. FIGS. 5 through 8 illustrate the FSBR system 100 in different processing stages, as will be described in more detail below.

As illustrated in FIG. 3, the FSBR system 100, in its simplest form, includes a reactor tank 104, a gas/liquid distribution system, indicated generally at 106, a waste activated sludge removal system, indicated generally at 108, and a control system, indicated generally at 110.

The reactor 104 has a top 112, a bottom 114 and side walls 116 and 118. Depending on the type of required treatment and end-use application of the system 100, the reactor 104 may also be provided with a cover 120 to enclose the contents of the reactor 104. For example, a cover may be required during an anaerobic and/or an anoxic React stage in order to apply positive or negative pressure to the contents of the reactor 104. Whereas, the reactor 104 may be covered or uncovered during an aerobic React stage, depending on particular end-use application of the FSBR system. It is further contemplated that the reactor 104 is a closed-top tank including an appropriate venting mechanism, as will be well known to those skilled in the art, so that aerobic, anoxic and/or anaerobic conditions can all be achieved in the same reactor 104.

The reactor 104 is preferably constructed of steel, fiberglass or concrete; however, any material known to those skilled in the art may be used, depending on the location of the reactor 104, the required industry or government-approved materials and/or the type of waste stream to be treated. The reactor 104 and/or the FSBR system 100 may be located above, at grade or below grade, depending on the required application of the system. As will be appreciated by those skilled in the art, the shape and size of the reactor 104 and all associated FSBR equipment will be determined by the organic loading (the concentration of the contaminants in the waste stream), the average and peak inflow requirements of the facility or municipality in which the system 100 is installed and/or the desired location of the FSBR system 100.

At least one inlet 122 is formed in the reactor 104 for feeding wastewater to the system 100. The inlet 122 will preferably located near the top of the reactor 104; however, the inlet 122 may be located anywhere within the reactor 104. The reactor 104 further includes at least one outlet 124 for decanting clarified effluent from the reactor 104. The outlet 124 is preferably located near the bottom of the tank; however, the outlet 124 may be alternatively located in any portion or position within the reactor 104 to maximize the volume of treated effluent removed from the reactor and/or to minimize the amount of solids removed with the treated effluent. In particular, where the FSBR is designed to function in a semi-batch or continuous mode, the inlet 122 and outlet 124 will preferably be located on opposite locations in the reactor 104, as will be appreciated by those skilled in the art.

In addition, the outlet 124 may be replaced by a decanting mechanism (such as a floating or fixed decanter) as will be well known to those skilled in the art. Consistent with the broader aspects of the present invention, the outlet 124 of the reactor 104 can be, for example, the nozzles provided as part of the gas/liquid distribution system 106, as described in more detail below.

The reactor 104 preferably includes at least one level indicator 126 for measuring, monitoring and/or relaying the level/volume of wastewater inside the reactor 104, as required by the control system 110. Additional monitoring devices may also be included within the reactor 104 including, but not limited to, devices/systems for monitoring one or more process variables such as temperature, pressure, pH, oxygen demand (DO and/or BOD), TOC, conductivity, oxidation-reduction potential (ORP), solids concentrations, specific contaminant concentrations including the on-line analysis of the major nutrients (ammonia, nitrate, nitrite and phosphate) and/or flow rates—as required by the control scheme of the FSBR.

Where odor control is an consideration, the reactor 104 may optionally include an odor control release aperture 128 and valve 130 for venting the reactor 104 in communication with an odor control system 132, for preventing release of gas into the environment. Technologies used for the odor control system 132 can include, but are not limited to, activated carbon filtration, chemical scrubbing and/or biofiltration. A solids resolution system 134 may also be provided in the reactor 104 to achieve a uniform suspension inside the reactor 104 after a complete treatment cycle has run, as will be described in more detail below.

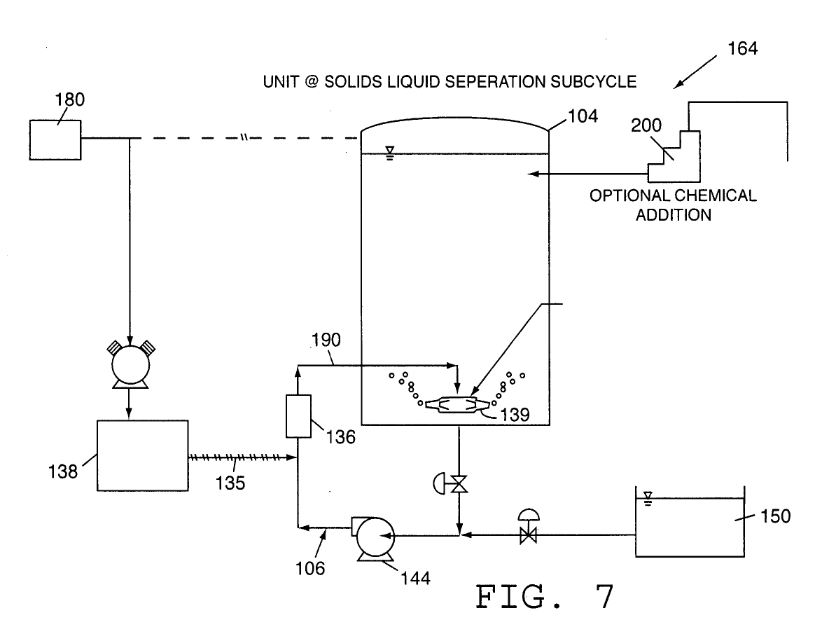

The gas/liquid distribution system 106 can provide several functions within the reactor 104. First, the gas/liquid distribution system 106 provides a hydraulic mixing and/or aeration function wherein mixing and/or aeration of the contents of the reactor 104 are required by the particular operating stage of the FSBR process 102. Importantly, the gas/liquid distribution system 106 also provides a solids flotation function wherein wastewater is supersaturated with dissolved gas and released into the reactor 104 causing the mixed liquor suspended solids within the reactor 104 to float to the surface, as described in more detail with respect to FIG. 7.

Accordingly, the gas/liquid distribution system 106 includes a saturation vessel 136 which is supplied with gas or air from a compressed gas/air supply 138 through a line 135 and a valve 137. The gas/liquid distribution system 106 also includes a plurality of nozzles or apertures 139 located within the reactor 104 for mixing, supplying air and/or floating the solids—depending on the operation step.

Wastewater is fed to the gas/liquid distribution system 106 from one or more process streams, as illustrated in FIG. 3. Wastewater can be drawn from the reactor 104 through an aperture 141 and line 140, having a control valve 142 therein, to a recirculation pump 144 which feeds the saturation vessel 136. In addition to or alternatively, treated effluent from a holding tank 150 (or supplied directly from the reactor outlet 124) can also be diverted to the recirculation pump 144 through a line 146 and a valve 148. Further, a portion of the wastewater entering the system 100 may be diverted through a line 151 and valve 152 to the supply the gas/liquid distribution system 106.

The compressed gas/air supply 138 of the gas/liquid distribution system 106 preferably utilizes air; however, any type of gas may be used including, but not limited to, oxygen or ozone.

The gas/liquid distribution system 106 also includes a line 154 and a valve 156 for bypassing the saturation vessel 136 when aeration and/or mixing of the reactor 106 is required. The compressed gas/air system may also be provided with a line 157 and a valve 158 for feeding the gas/liquid distribution system 106 when aeration and/or mixing functions, rather than the flotation function, is required.

As will be appreciated by those skilled in the art, the flotation function/operation of the gas/liquid distribution system 106 may be achieved utilizing any mechanism known to those skilled in the art to cause the suspended solids/activated sludge to float to the surface of the reactor 104. As such, the gas/liquid distribution system 106 may utilize dissolved air flotation (DAF), induced air flotation, bubble air flotation, electrical gas flotation, fine bubble air flotation and/or any other mechanical, biological and/or chemical means to float the suspended solids to the surface of the reactor 104. Further, it will be appreciated that the flotation function/operation of the gas/liquid distribution system 106 may be achieved without the need for a saturation vessel and/or a compressed gas/air supply, as will be commonly understood by those skilled in the art.

It will be appreciated by those skilled in the art that the integrated gas/liquid distribution system 106 of the present invention may instead be replaced by one or more systems for accomplishing the aeration, hydraulic mixing and/or flotation operations required for the FSBR process 102. In particular, each of the aeration, mixing and/or dissolved gas flotation functions may be separately provided as part of the FSBR system 100 of the present invention, as will be well known to those skilled in the art.

The waste activated sludge removal system 108 of the FSBR system 100 is optionally provided for removing WAS when required and includes a pump 149 and a valve 151. As will be appreciated by those skilled in the art, solids wasting can be performed using any appropriate mechanism or method including, but not limited to, collection ports, baffles, nozzles, floating valves, electromechanical devices and/or via complete mixing. Further, it will be appreciated that the nozzles 139 of the gas/liquid distribution system 106 may be used to remove WAS from the reactor 104.

Finally, as described in more detail with respect to the FSBR process 102 and FIG. 4 below, the control system 110 may be any such system known to those skilled in the art for controlling and monitoring the FSBR process/stages of operations, including, for example a programmable logical controller (PLC) controller, software, distributed control systems, etc. As such, the control system can be in communication with one or more devices for controlling or monitoring one or more process parameters/variables such as time, temperature, pressure, pH, oxygen demand (DO and/or BOD), TOC, ORP, conductivity, solids concentrations, specific contaminant concentrations including the on-line analysis of the major nutrients (ammonia, nitrate, nitrite and, if required, phosphate), turbidity and/or flowrates—as required by the control scheme of the FSBR process and as will be well known to those skilled in the art.

Turning next to FIGS. 4 through 9, a preferred FSBR process 102 is shown. As illustrated in FIG. 4, the FSBR process 102 can typically include, but is not limited to five steps or stages of operation: Fill 160, React 162, Solids/Liquid Separation 164, Draw 166 and Idle 168. In addition, the FSBR system 100 and process 102 of the present invention can include the deletion and/or repetition of one or more of these stages, if required by a given end-use application. Further, additional wastewater treatment methods such as biological, chemical and/or mechanical treatment, as will be well known to those skilled in the art, may be integrated into the FSBR system 100 and process 102 of the present invention as a matter of design choice and/or as required by the given system application.

Further, while the present invention is described with reference to a conventional SBR five-step process (Fill, React, Settle, Draw and Idle) as described herein, it will be readily apparent to those skilled in the art that the present invention is applicable and can be applied to any wastewater treatment system operation, process or method including those requiring aerobic or anaerobic conditions, chemical treatment, phosphorous removal, nitrification, denitrification, or any treatment process known to those skilled in the art. Thus, the present invention, and the inherent advantages achieved therewith, can be utilized with and/or integrated into any existing wastewater treatment system known to those skilled in the art including any batch, semi-batch, continuous and/or any other hybrid sequencing wastewater treatment system known to those skilled in the art.

Referring first to FIGS. 4 and 5, in addition to FIG. 3, during the Fill stage 160, wastewater 183 containing contaminants enters the system 100 from a source of wastewater 180, from which it flows through a feed line 182, having a valve 186 therein, through a screen 184, optionally provided to remove grit and/or larger particulate from the incoming wastewater. After screening and/or required pretreatment, the wastewater flows into the biological reactor 104. The reactor 104 contains activated sludge/biomass 192 already present in the FSBR from a previous cycle.

As described with reference to a conventional SBR Fill stage, the FSBR Fill stage 160 may include one or more operational strategies including static Fill, mixed Fill, aerated Fill and/or combinations thereof. Static Fill occurs under quiescent conditions (no mixing or aeration), meaning that there will be a high substrate (food) concentration when mixing begins. A high food to microorganisms (F:M) ratio creates an environment favorable to floc forming organisms versus filamentous organisms, which provides good settling characteristics for the sludge. Additionally, static fill conditions favor organisms that produce internal storage products during high substrate conditions, which is believed to be a necessary condition for biological phosphorus removal.

Mixed Fill is characterized by hydraulically mixing the influent wastewater with the activated sludge/biomass, which initiates biological digestion of the food by the microorganisms in the activated sludge. During mixed Fill, the gas/liquid distribution system 106 is utilized to mix the contents of the reactor 104 to sufficiently contact the activated sludge with the incoming waste stream such that the microorganisms biologically degrade the organic contaminants and use residual oxygen or alternative electron acceptors, such as nitrate-nitrogen or sulfate. Accordingly, mixed Fill may be utilized/required where an anoxic condition/environment is needed for denitrification (where nitrate-nitrogen becomes the electron acceptor). Anaerobic conditions can also be achieved during the mixed Fill stage, wherein sulfate becomes the electron acceptor. Aerated Fill is characterized by aerating the contents of the reactor in a manner sufficient to begin aerobic biological reactions (which will be completed in the React step). Aerated Fill can reduce the aeration time required in the React step.

As illustrated in FIGS. 3 through 5, the Fill stage 160 continues until a desired level L of wastewater is reached within the reactor 104, for a specified time period, as determined by the control system 110 and/or as required by the given FSBR process application. As will be appreciated by those skilled in the art, the Fill stage 160 can include varying periods of static, mixed and/or aerated conditions, depending on the required treatments e.g. nitrification, denitrification, etc.

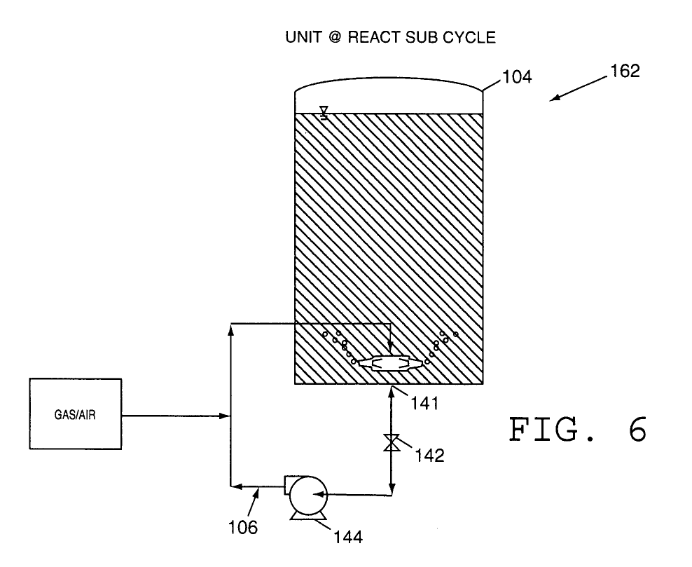

Turning next to FIG. 6, in addition to FIGS. 3 and 4, during the React stage, mixing and/or aeration of the wastewater in the reactor 104 is performed by the gas/liquid distribution system 106 (or alternatively by the aeration and/or hydraulic mixing systems where provided separately from the gas/liquid distribution system 106. Accordingly, the React stage may include one or more operational strategies including, but not limited to, quiescent periods, mechanical and/or gas mixing-only periods to achieve a homogenous mixture of the reactor contents, aeration-only periods to encourage biological digestion and/or intermittent aeration and mixing periods. Accordingly, anoxic and anaerobic stages, in addition to an aerobic React stage may be included within the FSBR process 102.

Turning next to FIG. 7, in addition to FIGS. 3 and 4, the Solids/Liquid Separation 164 stage is shown. During the Solids/Liquid Separation stage 164, the gas/liquid distribution system 106 activates to provide gas and/or air saturated wastewater to the reactor 104. As described herein, the gas/liquid distribution system 106 may utilize dissolved air flotation (DAF), induced air flotation, bubble air flotation, electrical gas flotation, fine bubble air flotation and/or any other mechanical, biological and/or chemical means to float the suspended solids to the surface of the reactor 104. Operating/saturation pressures, flowrates and temperatures of the gas/liquid distribution system 106 will depend on a number of process variables, including, but not limited to, flow rate, waste characteristics and/or water temperature, and are a matter of design choice, as will be well known to those skilled in the art.

Accordingly, during the Solids/Liquid Separation 164 stage, the high pressure saturation vessel 136 is supplied with air and/or gas from the source 138. Wastewater is supplied to the saturation vessel 138 from the recirculation line 140 from inside the reactor 104, from the treated effluent holding tank 150 and/or from the incoming source of wastewater 180, as determined by the control scheme required by the given FSBR application. Without limitation to any particular theory or mode of operation, air or gas at high pressure is dissolved into the liquid inside the saturation vessel 138 providing a substantially gas/air saturated liquid.

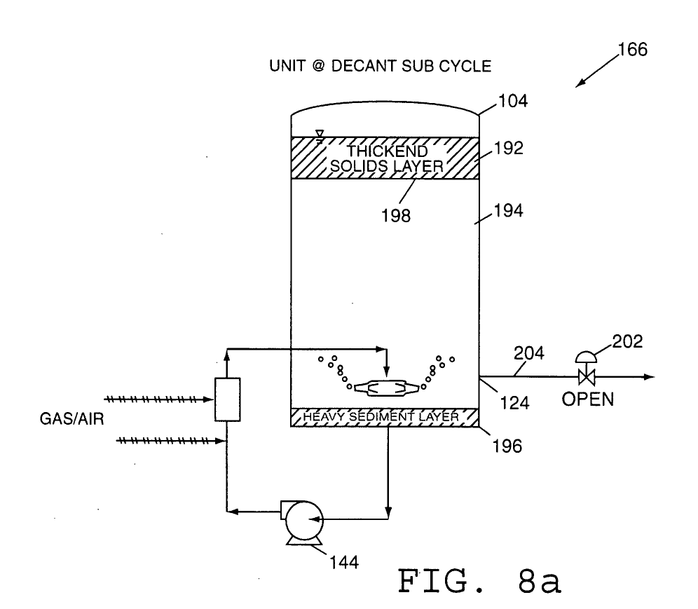

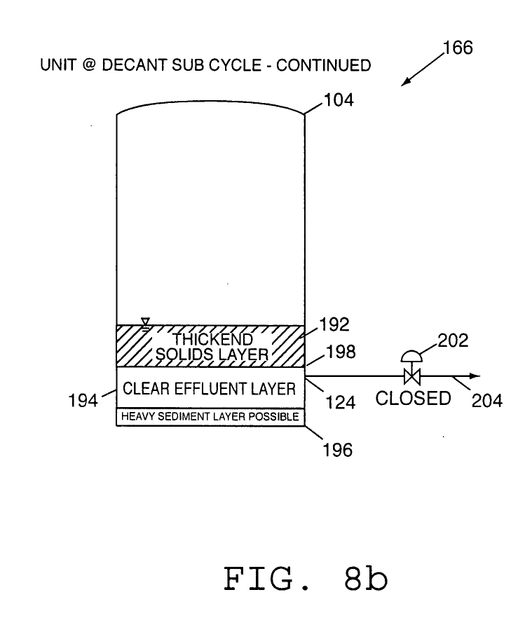

The saturated liquid is released from the saturation vessel 136 through a line 190 to the nozzles 139 where it is released into the reactor 104. Again, without limitation to any particular theory or mode of operation, the release of the saturated liquid into the reactor 104 causes small/fine bubbles to form throughout the reactor 104. The bubbles attach to the waste solids dispersed in the wastewater, decreasing the specific gravity of the solid particles and causing the solids to float to the top of the reactor 104. The floated solids form a thickened solids layer 192 above the clarified effluent 194 with an interface 198, as best illustrated in FIGS. 4 and 8a. Heavier suspended solids such as sand or large particles, not capable of flotation within the FSBR, sink to the bottom of the reactor 104 forming a heavy sediment layer 196.

Accordingly, the Solids/Liquid Separation 164 stage effects solids/liquid separation by floating the suspended solids in the wastewater to the surface of the water. The difference in the specific gravity of the floated solids and that of the water is sufficient to render the solids/liquid interface 198 relatively stable. The Solids/Liquid Separation 164 stage may continue until a desired effluent quality is obtained and/or for a given period of time, depending on the required control scheme of the FSBR. In addition, the Solids/Liquid Separation 164 stage may operate in any control scheme required by the FSBR application, including continuous and/or discontinuous/intermittent operation.

The Solids/Liquid Separation 164 stage may also include the addition of chemicals such as coagulants and/or flocculants through a chemical addition system 200, as required for the given waste stream and/or the final end-use application of the FSBR system 100.

Turning next to FIGS. 8a and 8b, in addition to FIGS. 3 and 4, the Draw stage 166 of the FSBR process 102 is illustrated. As illustrated in FIG. 8a, at the start of the Draw stage 166, the floated solids layer 192 is positioned above the treated effluent 194. The reactor outlet 124 is opened allowing treated effluent to flow into the effluent holding tank 150. The gas/liquid distribution system 106 may be designed to operate during the Draw cycle, may operate intermittently or may be stopped during the Draw cycle, depending on the given system requirements.

Preferably, clarified effluent is decanted from the reactor 104 through the outlet 124 and through the outlet valve 202 and line 204 into the effluent holding tank 150. It will be appreciated by those skilled in the art that rather than providing an outlet or opening in the side of the reactor 104 for decanting off the clarified effluent, any type of decanter mechanism including a floating or a fixed decanting system, nozzle and piping within the reactor, and/or the gas/liquid distribution system, can be used to draw off the treated effluent.

As best illustrated in FIG. 8b, at the end of the Draw stage 166, the floated solids layer 192 drops to the bottom of the reactor 104 as the clarified effluent is withdrawn. When the level in the reactor 104 reaches a certain position, the effluent quality reaches a certain value and/or an increase in solids is detected in the effluent stream, the outlet valve 202 is closed.

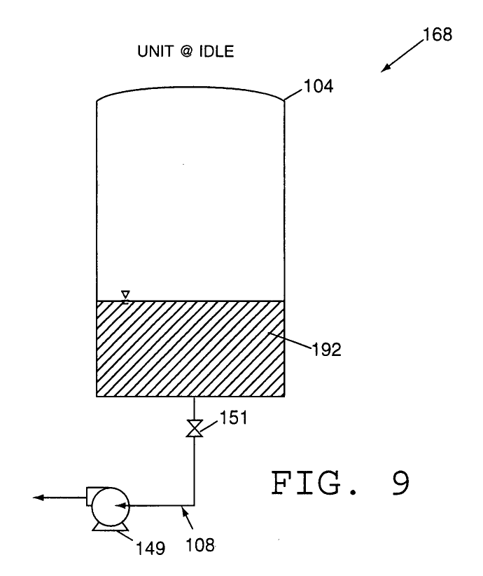

Turning next to FIG. 9, the Idle stage 168 is illustrated. In particular, during the Idle stage, waste activated sludge, if any, is removed from the reactor 104 using the waste activated sludge removal system 108. Further, the solids resolution system 134 may be used during the Idle stage 168 to mechanically homogenize the solids and residual liquid remaining inside the reactor 104 in preparation for the next cycle.

It may therefore be seen that the present invention provides several advantages over the conventional SBR system and process. In particular, in the traditional SBR process, because the specific gravity of the activated solids within the waste stream is sufficiently similar to that of the water, gravity provides inadequate driving force for separation of the solids from the liquid. Accordingly, conventional settling and draw stages can be lengthy and inefficient. However, in the FSBR of the present invention, the specific gravity of the floated solids is sufficiently less than that of the water, accordingly, the separation of the solids from the water in the waste stream is accomplished at much higher rates. For example, the Solids/Liquid Separation 164 stage of the FSBR process 102 of the present invention can reduce separation time from one to two hours in a typical SBR settle stage to less than about thirty minutes in the FSBR Solids/Liquid Separation 164 stage.

Further, in a conventional SBR, additional time is built into one or more of the processing modes/stages (for example, the settle and draw stages) to allow the microorganisms to “process the food” contained in the wastewater in order to create a stable biological environment that is amenable to gravity separation. This is particularly important where gassing in either an anaerobic reactor (i.e. carbon dioxide or methane) or an aerobic batch reactor (i.e. nitrogen) may maintain the solids in suspension. Accordingly, using flotation as an alternative to the gravity settling process can eliminate the need for such extended processing stages and shortens the overall time requirement of the batch process.

In addition, in the conventional SBR process, gravity provides an inadequate force for maintaining a stable solids/liquid interface; thus, any current or disruption of the clarified effluent in the reactor disturbs the solids/liquid interface and re-disperses the solids within the reactor. However, in the present invention, the gas/liquid distribution system 106 (the saturated liquid) provides the driving force for separation of the solids and retains them in the thickened solids layer. Accordingly, in the FSBR, the solids/liquids interface is more stable and less subject to disruption than in the convention SBR system. As such, the Draw stage can be performed at higher hydraulic rates than in the conventional SBR process.

Further, because the solids/liquid interface in the FSBR is more stable and less subject to disruption than the solids/liquid interface formed during gravity settling in a conventional SBR process, more clarified effluent (i.e. effluent disposed much closer to the solids/liquid interface) can be withdrawn from the FSBR reactor without also withdrawing solids.

Additionally, the thickened solids layer formed using the FSBR system and process of the present invention is more concentrated that that formed by a typical gravity settling scheme. Specifically, because the fine air bubbles attach themselves to the solid particles and float them to the top of the reactor—above the clarified effluent, the solids layer includes less entrained water than that contained in the solids layer formed in a typical SBR gravity settling process. As such, not only is a more concentrated, thicken solids layer formed using the FSBR process, it can be formed at much faster rates is formed at a great rate than that of the conventional SBR process.

Accordingly, because the FSBR solids/liquid separation can be accomplished in less time, because the floated solids layer is more concentrated and because decanting can begin earlier in the process and at higher rates than conventional batch processes, a greater percent volume of the reactor can be processed with each batch reactor cycle. For example, because the decant can start earlier, instead of decanting only about 25% of the reactor contents during a cycle (in a conventional SBR), a larger amount of clarified effluent, for example, about 75% of the reactor contents, may be decanted with each FSBR cycle.

One skilled in the art will readily recognize that the floating sequence batch reactor system and method of the present invention can be operated at higher MLSS concentrations over traditional SBR systems. In particular, use of a flotation solids/liquid separation stage versus a traditional gravity settle stage renders the MLSS concentration independent from sedimentation behavior and, therefore, thus permits the MLSS concentration to be increased compared to conventional SBR systems. In addition, the FSBR of the present invention allows higher activated sludge solids level to be utilized, allowing for a smaller biological volume to be utilized, and therefore, a smaller process footprint to be utilized over conventional SBR systems. In turn, high MLSS concentrations and high SRT promote other numerous process benefits including, but not limited to, stable operation, complete nitrification, and reduced waste production. Accordingly, the present invention can be less expensive and more efficient to operate over conventional systems. It will be appreciated that the FSBR system of the present invention has many additional advantages, as will be apparent to those skilled in the art.

As an additional advantage, the thickened, more concentrated solids layer can be removed from the floating sequencing batch reactor process without undergoing a further waste solids thickening unit process. Thus, the present invention provides a wastewater treatment system and method that saves substantial capital costs, operating costs and maintenance costs by eliminating the need for down stream solids thickening operations.

The present invention also provides a system and method wherein the treated effluent is easily decanted using a relatively simple decanting mechanism, i.e. via reactor wall penetration—eliminating the need for expensive and complex floating decanting devices and/or stationary baffles. In addition, because the solids are floated to the top of the reactor, there is less chance of solid particles clogging or damaging the nozzles and related equipment for the gas/liquid distribution system, the aeration system and/or the mixing system at the bottom of the reactor. Thus, the FSBR system and method of the present invention are economical to purchase, operate and maintain.

It may also be seen that the present invention provides an improved wastewater treatment system and method that is adaptable/configurable for use with substantially all types of mixing and/or aeration processes currently used in biological batch reactor processes. Further, the FSBR system and methods of the present invention can be used to retrofit existing wastewater treatment sites, providing the ability to more than double the capacity of existing installations.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. A wastewater treatment system, comprising:
(a) a reactor vessel;
(b) a wastewater inlet coupled to the reactor vessel to provide wastewater to be treated to the reactor vessel;
(c) a treated effluent outlet coupled to the reactor vessel to remove treated effluent from the reactor vessel;
(d) a gas/liquid distribution system coupled to the reactor vessel to provide a solids flotation function wherein a liquid source is supersaturated with a dissolved gas and released to the reactor vessel; and
(e) a control system coupled to the wastewater inlet, the treated effluent outlet, and the gas/liquid distribution system and adapted to:
(i) control wastewater flow from the wastewater inlet into the reactor vessel to allow a reaction stage to take place;
(ii) control the gas/liquid distribution system to activate the solids flotation function to cause solids to float to a top of the reactor vessel after the reaction stage, thereby leaving treated effluent below a layer of solids; and
(iii) control treated effluent flow from the treated effluent outlet after solids floatation to achieve a desired effluent quality.

2. The wastewater treatment system of claim 1 wherein the gas/liquid distribution system is also adapted to provide hydraulic mixing and/or aeration of contents of the reactor vessel.

3. The wastewater treatment system of claim 1 wherein the gas/liquid distribution system is coupled to a liquid source selected from the group of liquid sources consisting of sources of incoming wastewater, recirculated wastewater and treated effluent.

4. The wastewater treatment system of claim 1 wherein the gas/liquid distribution system includes a saturation vessel coupled to a compressed gas/air supply and to the liquid source.

5. The wastewater treatment system of claim 4 wherein the compressed gas/air supply provides a compressed gas selected from the group of gasses consisting of air, oxygen and ozone.

6. The wastewater treatment system of claim 1 wherein the gas/liquid distribution system includes a plurality of nozzles positioned in the reactor vessel.

7. The wastewater treatment system of claim 1 wherein the gas/liquid distribution system provides a solids flotation function selected from the group of solids flotation functions consisting of dissolved air flotation, induced air flotation, bubble air flotation, electrical gas flotation, and fine bubble flotation.

8. The wastewater treatment system of claim 1 wherein the control system includes one or more of manual control, a programmable logic controller, computer software, and a distributed control system.

9. A method for wastewater treatment comprising:
(a) contacting an incoming wastewater stream with activated sludge in a reactor vessel;
(b) providing gas-saturated liquid to the reactor vessel for a sufficient time to cause suspended solids in the reactor vessel to float to the surface of the reactor vessel contents; and
(c) drawing off clarified effluent at a point within the reactor vessel below the floating suspended solids.

10. The method of claim 9 comprising additionally hydraulic mixing and/or aeration of the contents of the reactor vessel.

11. The method of claim 9 wherein the gas saturated liquid is a liquid selected from the group of liquids consisting of incoming wastewater, recirculated wastewater and treated effluent.

12. The method of claim 9 wherein gas saturated liquid includes a gas selected from the group of gasses consisting of air, oxygen and ozone.

13. The method of claim 9 wherein providing gas-saturated liquid to the reactor vessel provides a solids flotation function selected from the group of solids flotation functions consisting of dissolved air flotation, induced air flotation, bubble air flotation, electrical gas flotation, and fine bubble flotation.
